(19) United States
(12) Patent Application Publication
(10) Pub. No.: US 2024/0243538 A1
(43) Pub. Date: Jul. 18, 2024

(54) LIGHTING QUICK DISCONNECT DEVICES

(71) Applicant: SKYX Platforms Corp., Johns Creek, GA (US)

(72) Inventor: Ran Roland KOHEN, Aventura, FL (US)

(73) Assignee: SKYX Platforms Corp., Johns Creek, GA (US)

(21) Appl. No.: 18/274,030

(22) PCT Filed: Jan. 25, 2022
(86) PCT No.: PCT/US2022/013598

§ 371 Date: Jul. 25, 2023

Related U.S. Application Data
(60) Provisional application No. 63/141,098, filed on Jan. 25, 2021.

(51) Int. Cl. H01R 33/18; F21V 23/04; F21V 23/06; F21Y 115/10; H01R 13/627; H05B 45/20

(52) U.S. Cl. CPC H01R 33/18; F21V 23/0471; F21V 23/06; H01R 13/6271; H01R 13/6276; H05B 45/20; F21Y 2115/10

(57) ABSTRACT

A quick connect plug and socket connect an electrical fixture to an electrical socket. The socket has concentric ring-shaped openings with adjacent internal contact terminals which are electrically connected to an electrical power supply wiring. The plug is insertable into the socket and has ring-shaped connectors that mate with the contact terminals within the socket. The plug and socket become latched when mated, and a latch release is pushed to allow them to be separated. A housing encloses portions of the plug and encloses a plurality of peripheral LEDs. A peripheral lens attached to the housing allows light from the LEDs to pass. The intensity and color of the LEDs are controlled by an electronic circuit based upon a signal. The latch release moves transversely to a central axis extending through the concentric rings, so that it can be pressed when the plug and socket are within an enclosing canopy.

### FIELD OF THE DISCLOSURE

The disclosure relates to electrical connectors and fixtures, and more particularly to an electrical plug and socket combination enabling tool-less connection and mounting of electrical fixtures at electrical outlets, the connector and/or fixtures including a release and attachment latch mechanism, and additionally to such fixtures including auxiliary lighting for safety or signaling.

### LISTING OF RELATED PATENTS AND APPLICATIONS

This disclosure relates to U.S. Patent Application No. 62/486,132 filed Apr. 17, 2017; PCT International Patent Application No. PCT/US18/27956 filed Apr. 17, 2018 (published as WO 2018/195068 A1); U.S. Patent Application No. 62/467,176 filed Mar. 5, 2017; PCT International Patent Application No. PCT/US2016/032170 filed May 12, 2016 (published as WO 2016/183354 A1); U.S. Pat. No. 7,462,066 filed Mar. 20, 2007; 7,192,303 filed Dec. 2, 2004; and 6,962,498 filed Dec. 12, 2001; and to U.S. Patent Application Publication No. 2009/0280673 filed Dec. 2, 2005; U.S. Provisional Applications 62/160,585 filed May 12, 2015; 62/308,718, filed Mar. 15, 2016; 62/467,176 filed Mar. 5, 2017; 62,470,170 filed Mar. 10, 2017; 62/515,464, filed Jun. 5, 2017; U.S. Patent Application No. 62/807,889 filed Feb. 20, 2019 (published as WO 2020/172390A1); U.S. Provisional Application 62/543,912 filed Oct. 8, 2017; U.S. Provisional Application 63/019,954, filed May 4, 2020; and PCT International Patent Application No. PCT/US2018/20987 filed Mar. 5, 2018 (published as US2020018469), the contents of all of which are hereby incorporated by reference herein, in their entirety.

### BACKGROUND OF THE DISCLOSURE

There are a number of commercially available systems termed ‘smart-home environment’ systems, which can include one or more sensors and network-connected devices. These smart-home devices can sometimes intercommunicate and integrate together within the smart-home environment. The smart-home devices may also communicate with cloud-based smart-home control and/or data-processing systems in order to distribute control functionality, to access higher-capacity and more reliable computational facilities, and to integrate a particular smart home into a larger, multi-home or geographical smart-home-device-based aggregation.

Techniques for installing electrical fixtures and appliances such as lighting fixtures and fans on walls or ceilings usually require the assistance of a qualified electrician, and the use of a variety of tools and specialized hardware. The procedure for installing or uninstalling such fixtures can also be relatively time consuming, even when performed by an experienced installer, and can be hazardous. In addition to the need for hand-wiring the necessary electrical connections between the fixture and electrical power supply wiring, the installer must make separate mechanical connections for supporting or suspending the fixture in place.

### SUMMARY OF THE DISCLOSURE

In accordance with the disclosure, a device for connecting an electrical fixture to an electrical socket of the type including a socket body has an internal cavity which contains concentric ring-shaped openings with adjacent internal contact terminals which are electrically connected to an electrical power supply wiring, the device further includes a plug rigidly fixed to the fixture and insertable into the socket, the plug having one or more male ring-shaped connectors electrically connected to the fixture and mateable with the one or more contact terminals within the socket to establish a circuit between the electrical fixture and the electrical power wiring, and a releasable latch carried on the combination of the plug and the socket for releasably mounting the fixture on the support. The device further comprises a housing containing an electronic circuit, the housing sized to contain a portion of the plug, the housing defining an exterior perimeter; and a light source connected to the electronic circuit, the light source positioned to emit light circumferentially about the exterior perimeter; the light source controllable by the electronic circuit to emit light at a selected color of a plurality of colors.

In a variation thereof, the housing is enclosed by a canopy; the canopy includes a light passing lens positioned circumferentially about a perimeter of the canopy; the housing includes a plurality of apertures about the exterior perimeter for passing light of the light source; the housing includes a plurality of apertures about the exterior perimeter for passing light of the light source, the light passing lens positioned proximate the plurality of apertures; the device further includes a plurality of LEDs disposed peripherally about the plug, and a lens covering the plurality of LEDs is configured to diffuse the light from the LEDs; and/or the device further includes an electronic circuit connected to the plug, the plurality of LEDs connected to the electronic circuit, the electric circuit configured to change a color and/or light intensity of the LEDs in response to an electrical signal.

In further variations thereof, the device further includes a sensor, the electrical signal generated by the sensor; the sensor is a motion sensor; the releasable latch includes a pin movable between a latched and an unlatched position, the pin movable within a spindle affixed to the plug, the spindle extending through a central axis of the ring-shaped contact terminals of the socket when the plug is inserted within the socket, the latch movable along a path transverse to central axis, the latch movable to move the pin along the central axis; and/or the device further includes a canopy sized larger than the housing and affixable to the housing, the canopy including a button pressable when the canopy is affixed to the housing, the device further including an end effector extending between the button and the lever, whereby the latch is moved when the button is moved.

In another embodiment of the disclosure, a device for connecting an electrical fixture with an electrical signal includes a socket including a socket body having a plurality of ring shaped internal cavities therein; an electrically conductive contact terminal disposed within each of a plurality of the cavities for establishing an electrical connection between an electrical signal and the socket; a bore formed within the socket and including a narrowed portion; a plug attachable to the fixture the plug having a body including a plurality of electrical terminals accessible from an exterior of the body; the plug having a plurality of ring shaped electrical contacts each mateably passable through a ring shaped internal cavity of the socket and engageable with a contact terminal within the socket to establish a circuit between the electrical fixture and the electrical signal; the fixture electrically connectible to the plurality of ring shaped electrical contacts of the plug by connecting one or more wires of the fixture each to one of the plurality of electrical terminals of the plug; a spindle connected to the plug and insertable into the bore of the socket; a pin slideable within the spindle; one or more channels extending through the spindle; one or more retaining balls each disposed within one of the one or more channels; the pin cooperative with the retaining balls and channels to slide within the spindle to a latch position to push the one or more retaining balls radially outwards within their respective channels to engage the narrowed portion of the socket bore to retain the spindle within the socket bore, and slide within the spindle to an unlatched position to not push the one or more retaining balls radially outwards within their respective channels to thereby enable release of the spindle from within the socket bore; the device further comprising a housing enclosing portions of the plug; a plurality of LEDs disposed peripherally about the housing; and a lens covering the plurality of LEDs.

In variations thereof, the plurality of LEDs are positioned upon a ring, and the device further includes a plurality of apertures each positioned adjacent an LED to thereby admit passage of light from an interior of the housing to an exterior of the housing; the lens diffuses the light from the LEDs; and/or the housing is formed from a top portion on a side of the plug adjacent the spindle, and a bottom portion positionable on a side of the plug opposite to the spindle, the housing enclosing an electronic circuit connected to the LEDs.

In a further embodiment of the disclosure, a method of communicating information with light, comprises providing a device for connecting an electrical fixture to an electrical socket of the type including a socket body having an internal cavity which contains one or more electrically conductive and concentric ring-shaped contact terminals which are electrically connected to an electrical power supply wiring, the device including a plug rigidly fixed to the fixture and insertable into the socket, the plug having one or more male connectors electrically connected to the fixture and mateable with the one or more contact terminals within the socket to establish a circuit between the electrical fixture and the electrical power wiring; and a releasable latch carried on the combination of the plug and the socket for releasably mounting the fixture on the support, the device comprising: a housing containing an electronic circuit, the housing sized to contain a portion of the plug, the housing defining an exterior perimeter; a light source connected to the electronic circuit, the light source positioned to emit light circumferentially about the exterior perimeter; the light source controllable by the electronic circuit to emit light at a selected color of a plurality of colors; and using the electronic circuit to sense a condition in the area proximate the device and controlling at least one of the color, intensity, and timing of the light source using the electronic circuit to communicate the sensed condition.

In variations thereof, the device further includes a motion sensor, the sensed condition including motion; a plurality of devices are positioned along a path, whereby motion detected illuminates a portion of the path along which motion is detected; the light source is controlled to indicate a relative state of the sensed condition by at least one of selecting a different color emitted for each of the relative states, selecting a different intensity emitted for each of the relative states, and selecting a different timing of emitting light for each of the relative states; and/or the sensed condition is a state of healthfulness in the area of the device using at least one sensor, the light source controlled to indicate a relative state of healthfulness in the area of the device.

### BRIEF DESCRIPTION OF THE DRAWINGS

A more complete understanding of the disclosure, and the attendant advantages and features thereof, will be more readily understood by reference to the following detailed description when considered in conjunction with the accompanying drawings, in which:

FIG. 1 depicts a perspective view of a device for suspending a lighting or other fixture and including a quick connect and a controllable light source in accordance with the disclosure;

FIG. 2 depicts a bottom view of the device of FIG. 1;

FIG. 3 depicts a side view of the device of FIG. 1;

FIG. 4 depicts a cross-section of the device of FIG. 1 taken through line A-A of FIG. 3;

FIG. 5 depicts an exploded perspective view of the device of FIG. 1;

FIG. 6 depicts a perspective view of the device of FIG. 1, illuminated with a white light;

FIG. 6A depicts a perspective view of the device of FIG. 6, illuminated with a non-white color;

FIG. 7 depicts an alternative type of device including a pole or cable for suspending a lighting or other fixture and including a quick connect and a controllable light source in accordance with the disclosure, the device also including a light ring illuminated in a color;

FIG. 8 depicts internal components useable within the plug of FIG. 1, including a side release mechanism;

FIG. 9 depicts the components and side release mechanism of FIG. 8, portions of the release mechanism isolated from remaining internal components;

FIG. 10 depicts components of the side release mechanism of FIG. 9 disposed within a canopy, the canopy supporting sensors, with remaining components of the plug removed for clarity, the canopy including a side release button;

FIG. 11 depicts a view of a socket of the disclosure, useable together with a plug of the disclosure; and

FIG. 12 depicts a cross section of a socket and plug, as useable within the disclosure.

### DETAILED DESCRIPTION OF THE DISCLOSURE

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The term “discreet,” as well as derivatives thereof, references to the amount of skin exposed by a user of the garment, rather than the type of style of the garment. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A; B; C; A and B; A and C; B and C; and A, B, and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Headings are provided for the convenience of the reader, and are not intended to be limiting in any way.

The disclosure herein relates to the inventor's prior work, such as that set forth above in the documents identified in the Related Patents and Applications section, the contents of each of which are herein incorporated in their entirety by reference.

This disclosure relates to providing additional safety for electrical fixtures supported/suspended by electrical wires, and sets forth improvements related to various embodiments of the plug and socket combinations in related patents and applications of the inventor which include a suspension cable carrying electricity. Lighting fixtures that include or are retrofitted to provide plug and socket combinations with a wire cover are additionally disclosed herein.

As described in additional detail in the incorporated references, the plug and/or socket can include a sensing unit for at least one of wirelessly communicating a sensed condition and wirelessly receiving a signal, particularly as disclosed in PCT International Patent Application No. PCT/US2016/032170 filed May 12, 2016 and PCT International Patent Application No. PCT/US2018/020987 filed Mar. 5, 2018.

A “quick connect device” for installing electrical fixtures comprises the combination of a plug and mating socket, which is also known as a receptacle. This combination is described in great detail in the incorporated references, and is summarized herein for the convenience of the reader. The plug and mating socket of the device function to both establish an electrical connection between an electrical fixture and electrical supply wiring, and mechanically support the fixture on a surface or base, typically a wall, ceiling or floor surface.

As used herein, the term “fixture” or “electrical fixture” means any fixture or appliance such as a lighting fixture, ceiling fan, television camera, security device or any other device which is powered by electricity supplied by electrical wiring, and which requires a mechanical connection to support or suspend the fixture.

The plug is fixedly secured to an electrical fixture, while the socket is secured to either the surface (e.g., wall, ceiling or floor) on which the fixture is to be mounted, or to an electrical junction box. The structure, function, and operation of the plug and mating socket, generally, have already been detailed in, for example, the patents and application incorporated by reference herein.

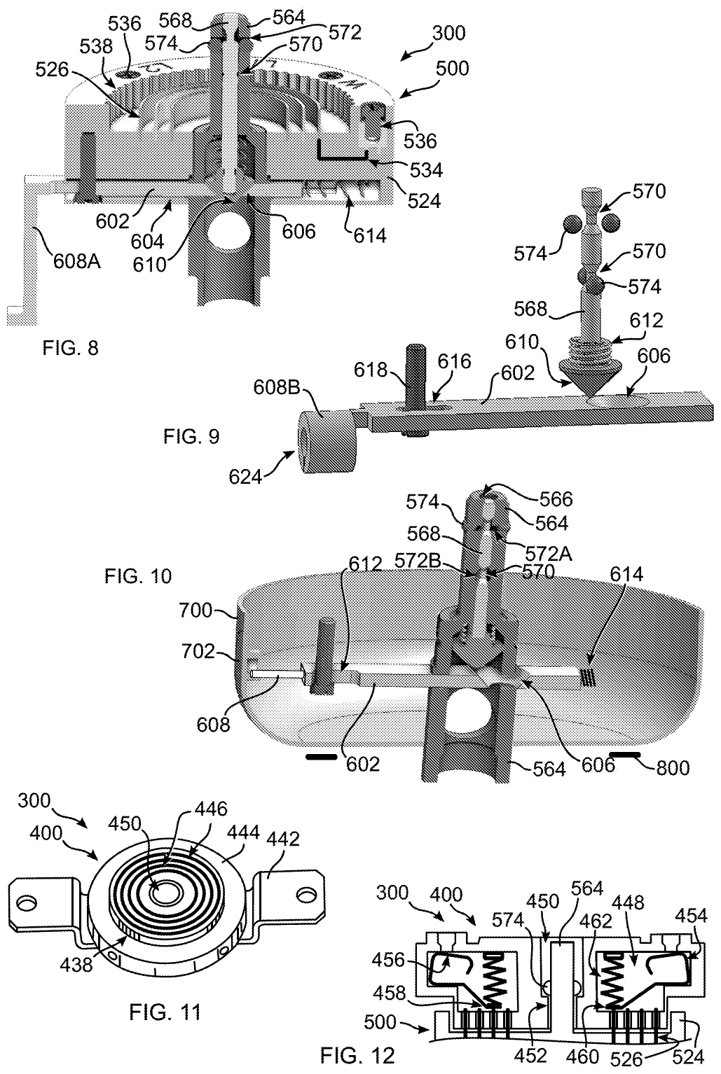

With reference to FIGS. 8-12, and with additional reference for example to the incorporated reference published as PCT/US2016/032170 (the ““170 publication”), a quick connect device 300 for installing electrical fixtures comprises the combination of a plug 500 and mating socket 400. In addition to the description herein, a further detailed description of the structure and function of a plug 300 is provided in the '170 publication and other incorporated references. A plug and socket quick connect is further described in the U.S. National Electric Code.

The basic functionality of socket 400 and plug 500 are known, as disclosed in the incorporated references, and as codified in the U.S. National Electric Code. By way of review; as can be seen in FIGS. 11-12, socket 400 may include a mounting strap 442 for attaching socket 400 to an electrical box or other supporting structure. A hollow body 444 includes a plurality of concentric ring shaped openings 446 which are open to the hollow interior 448 of body 444. A central bore 450) defines a bore diameter, and at least one narrowed bore diameter portion 452. A plurality of internal conductors 454 are each connectable at a connection end 456 to an electrical source of power and/or signal (hereinafter collectively “signal”), and at a contact end 458 at contactor 460. Each of the contactors 460 is positioned adjacent to an end of a ring shaped opening 446 within the interior 448, and is biased in a direction of ring shaped opening 446, for example by a contactor spring 462.

Plug 500 includes a body 524 supporting a plurality of concentric conductive rings 526 each connected by an internal conductor 534 to a terminal 536 (FIG. 8) to which can be attached an electrical signal. A wire entry port (not shown) for inserting a wire into terminal 536 can be provided upon a side surface of body 524. As can be seen in FIG. 12, each of the conductive rings 526 is insertable into one of the ring shaped openings 446 to make contact with a contactor 460, which is positioned to contact an inserted conductive ring 526 along at least one area about the perimeter of conductive ring 526.

Alignment spline 538 can be disposed about a peripheral portion of body 524, positioned to mate with alignment spline 438 of socket 400, to prevent radial rotation of plug 500 relative to socket 400 after plug 500 and socket 400 are connected.

A spindle 564 having a hollow spindle bore 566 is connected to body 524 to extend axially away from a center of body 524. A pin 568 having at least one narrowed pin diameter portion 570 is slidable within spindle bore 566. Spindle 564 includes one or more radial channels 572. Pin 568 can be slid within bore 566 to position narrowed pin diameter portion 570 adjacent a radial channel, in an unlatched position of pin 568. One or more retaining balls 574 are each positioned within a radial channel.

Spindle 564 is inserted within socket bore 450 when connecting socket 400 and plug 500, when pin 568 is in the unlatched position. In this position, narrowed bore diameter portion 452 of socket 400 can urge retaining balls 574 within the narrowed bore diameter portion 452 radially inwards towards a central axis of spindle bore 566, whereby a portion of each retaining ball 574 lies within channel 572, and a portion lies within the narrowed pin diameter portion 570). When spindle 564 is fully inserted within socket bore 450, radial channels 572 are positioned outside of narrowed bore diameter portion 452 within the larger diameter of socket bore 450. As such, pin 568 can be slid within spindle bore 566 to position narrowed bore diameter portion 452 away from and out of alignment with any of radial channels 572, to a latched position. In the latched position, each of retaining balls 574 is forced radially outwards by the wider general diameter of pin 568 to be positioned partly within radial channel 572 and to extend partly outside of radial channel 572 to lie partly within the larger diameter of socket bore 450. As such, a diameter defined by a retaining ball extending in this manner together with the diameter of spindle 564 is greater than the diameter of narrowed bore diameter portion 452, and spindle is thus unable to pass through narrowed bore diameter portion 452 and cannot be withdrawn from socket 400.

In an embodiment shown in FIGS. 9-10, two radial channels 572A, 572B are thus configured, but are disposed 90 degrees offset relative to each other, to provide additional pull-out strength. Additional detail is provided in, for example, incorporated references PCT/US2018/027956 and PCT/US2020/019010.

As described above, pin 568 is moved axially within spindle bore 566 to move between latched and unlatched positions. In another embodiment, FIGS. 8-10 illustrate that a radial motion can be translated to cause axial motion of pin 568. More particularly, a release lever 602 is slidingly received in a channel 604 that is transverse to a central axis of socket 500. Lever 602 includes a lever cam surface 606.

Further, pin 568 is provided with a cam follower 610 which slidingly mates with lever cam surface 606. Mating engagement of lever cam surface 606 and pin cam follower 610 enables pin 568 to move into the latched position, urged by a cam spring 612 which is positioned between a surface of spindle 564 (as shown) or body 524 and a surface of pin 568 or a surface attached to pin 568 (as shown). A lever spring 614 extending between body 524 and release lever 602 urges lever 602 into this mating position to further encourage locking of plug 500 to socket 400.

An end effector 608/608A/608B is disposed at an end of lever 602 and is pushed or pulled to move lever cam surface out of mating engagement with pin cam surface 606, and to drive pin 568 into an unlatched position. End effectors 608, 608B are substantially aligned with an axis of movement of release lever 602, while end effector 608A includes a portion that is substantially offset from this axis. An offset can be selected which positions end effector 608 in a convenient location for use. Guide channel 616 and guide pin 618 can be provided to cooperatively define a limit of movement of lever 602, as well as to guide movement of lever 602. An end effector connector 624 can be provided into which an end effector 608 can be inserted or otherwise attached. Additional detail is provided in incorporated reference WO 2020/172390A1. FIG. 10 depicts a canopy 700 positioned to cover spindle 564, release lever 602, and a remainder of plug 500 (portions not shown in FIG. 10 for clarity). As detailed in the 170) publication, one or more sensors 800 or other receiving/input or transmitting/output electronic or electrical devices (hereinafter collectively ‘sensors’) can be associated with either plug 500 or socket 400. These can be positioned, for example, upon canopy 700. An electrical wire (not shown) can pass from sensor 800 to a terminal 536 on plug body 524, to be electrically connected to a conductive ring 526 by a conductor, as described herein, or may be connected to an electronic circuit board associated with socket 400 or plug 500. The presence of such sensors 800 may render the associated device a ‘smart’ device, which can be a power consuming device such as a light or fan, which may or may not include ‘smart’ electronics or components, or other electronics which are unrelated to the operation of the device itself.

A lever actuator button 702 can be positioned upon canopy 700 to be aligned with end effector 608, and can be pressed to contact end effector to thereby push release lever 602 to move pin 568 to the unlatched position. FIG. 10 depicts pin 568 in the unlatched position, with pin cam follower 610 out of mating engagement with lever cam surface 606.

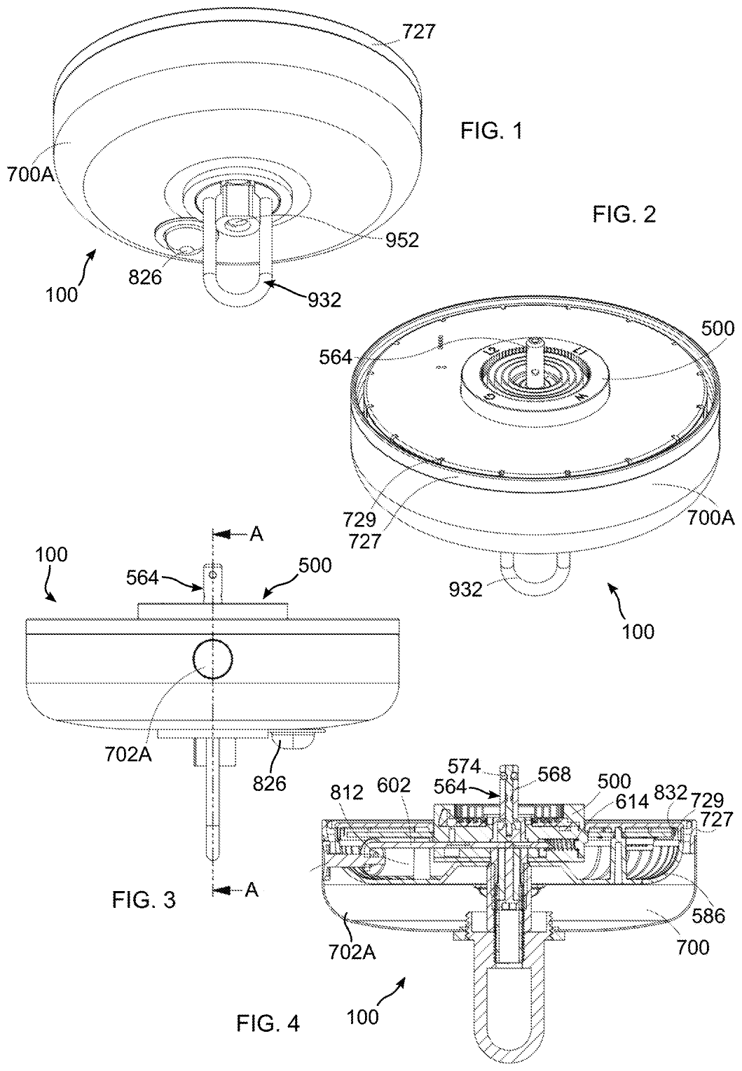

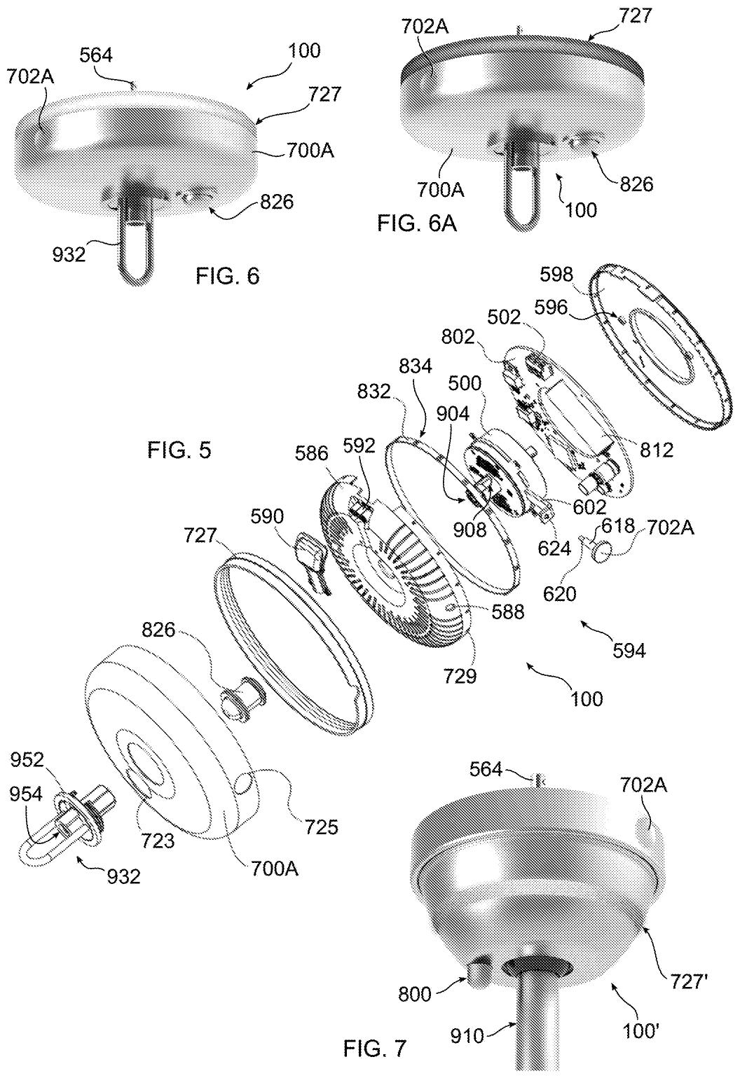

With reference to FIGS. 1-5, an electrical fixture device 100 has the form of a quick connect device as described above, and in the embodiment shown, the form of a smart quick connect device as detailed in the incorporated Publication US2020018469 (469 Publication). Bottom and top enclosures 586, 598 collectively form a housing 594 for quick disconnect plug 500, electronic circuit 802, and LED ring 832. Light apertures 729 pass light generated by LED ring 832 outside of bottom enclosure 586. Top enclosure 598 includes threaded mounting apertures 596 which facilitate mounting to straps, electrical boxes, or other structure, so that device 100 can be incorporated into an edifice. Electronic circuit 802 can include any of the components and features of circuit 15, 626, 630, 654A-B. 710 or other electronic circuit of the '469 Publication. LED ring 832 is electrically connected to circuit 802 and can be powered and controlled by circuit 802 to generate light in white or in various colors and light patterns, as represented in FIGS. 6-11. LED ring 832 can alternatively be connected to a ring 526 to obtain a signal via terminal 536.

In an embodiment, a fixture wiring terminal 502 is provided upon circuit 802, and power or signal wires from a light generating element, such as a lighting fixture, or wires from another type of quick connect enabled device, can be electrically connected to circuit 802. A wiring passthrough 592 can be provided upon bottom enclosure 586 for support and alignment of wires. A terminal wire cover 590 can be provided to prevent accidental access to circuit 802 and to further secure wires connected to wiring terminal 502.

A fixture wire passthrough 954 enables a wire or cable of wires to pass through finial mounting nut 952 or other fixture attachment hardware. Such wire or cable can include a lamp wire, and or other wires which can be interconnected between circuit 802 and a light or other object attached to canopy 700A and housing 594. Alternatively, a wire or cable passing through wire passthrough 954 can connect via a ring 526 and terminal 536 to one or more signals provided by socket 400. In an embodiment, such a wire or cable can pass to circuit 802 first, and from circuit 802 to a ring 526. As such, circuit 802 can change a signal between a connection via a ring 526 and the attached electrical fixture.

In an embodiment, a battery 812 is provided for continuing operation when power supplied from the edifice by wire or induction charging is not operational. Alternatively, battery 812 can independently provide the power needed for operation of device 100, and an access hatch (not shown) can be provided for replacement of battery 812.

Bottom enclosure 586 can include a release aperture 588 through which a release lever end effector or segment 618 can pass, to engage a side push release lever 602 of a side push release mechanism. In the embodiment shown, release lever 602 includes a lever button end 702A contactable by a finger on an exterior of device 100, and an opposed lever end 620 which can be threaded or press-fit or otherwise inserted into or attached to release arm mounting connector 624 of the side push release mechanism. A side push spring 614 biases push release arm 602 into a locked or engaged position, retaining device 100 into mating engagement with a socket portion of a quick disconnect. A side release mechanism is further described in more detail, for example, in incorporated reference WO 2020/172390A1.

In an embodiment, a canopy 700A covers the housing 594 formed by top and bottom enclosures 598, 586. In this manner, various types and styles of lighting (or other) fixtures can be fastened to the enclosure and unique attributes and styles can be configured with the features associated with the elements within housing 594 described herein, without a requirement of providing a housing 594 configuration for all of the various types and styles.

Canopy 700A can include a hanging fixture loop 932, which passes through an aperture in canopy 700A and threads into a spindle extension 904 attached to spindle 564. Spindle extension 904 can be hollow to admit passage of a wire or cable as described herein, and can include an extension opening or slot 908 which permits the wire or cable to emerge inside housing 594. A finial mounting nut 952 adjustably secures canopy 4 to hanging fixture loop 932 and housing 594.

In the embodiment shown, a WiFi antenna 826 is mounted to canopy 700A, connected by wires (not shown) to, for example, circuit 802. A WiFi mounting aperture 723 can be provided for attaching the WiFi antenna 826. Other devices as described in the '469 Publication and other incorporated references can be provided upon canopy 700A and connected to circuit 802 in addition to or instead of WiFi antenna 826. A release actuating aperture 725 is provided so that lever button end 702A can be accessed, or through which end effector 608 or end effector segment 618 can pass.

Canopy 700A can be provided with a canopy lens 727 through which light from LED ring 832 may pass, positioned adjacent to light apertures 729. Alternatively, in place of canopy lens 727, there may be formed a continuous gap or discrete openings (not shown) in canopy 700A through which light from LEDs 834 can emerge. In the embodiment shown, light apertures 729 and canopy lens 727 peripherally surround housing 594 and canopy 24, respectively. In this manner, light emitted by LED ring 832 is emitted circumferentially about canopy 700A after passing through lens 727, which can also be configured as a diffuser, which more evenly distributes light from discrete LEDs 834 to produce a seamless light ring effect when viewed. For example, lens 727 can have a frosted attribute or other light diffusing attribute or finish. Alternatively, lens 727 can extend along a portion of canopy 700A, and can optionally including diffusing properties, to produce shaped light region, which can include symbolic shapes such as letters, tokens, or other symbols.

LED ring 832 can have a ring shape, as shown, or other shape corresponding to lens 727 or other opening in canopy 700A, whereby a substrate holds a plurality of spaced apart LEDs 834. Alternatively, LEDs may be mounted directly to and peripherally about circuit 802. Still further LEDs can be spaced apart on a linear strip that is bent to form a circular or other shape. Likewise, if canopy 700A is not circular. LEDs can be positioned with respect to housing 594 and canopy 700A to shine light along a periphery of any shape, by being either mounted directly to circuit 802 mounted to bottom or top enclosure 586, 598, or mounted to a shaped strip or shaped loop. Similarly, canopy lens 727 can follow a desired peripheral shape, and can act as a diffuser or pass light therethrough unchanged. Alternatively, canopy lens 727 can have a non-clear tint or film, whereby light hues are shifted by canopy lens 27, or whereby an undesired portions of a light spectrum are attenuated or filtered, or desirable portions are emphasized.

Using housing 594 together with a separate canopy 700A provides for a universal inner fixture and a selectable external shape or style. In an alternative, canopy 700A forms and replaces bottom enclosure 586, serving as either part of, together with top enclosure 598, or all of an inner housing while providing an external finish.

While LEDs currently are optimal lighting elements, as they are energy efficient, and can be configured to emit a wide array of colors electronically, it should be understood that other light forms can be used which exist as of this writing, including incandescent, fluorescent, halogen and others, and that in the future other light sources may be used as substitutes for LEDs. and that the disclosure is not limited to LED light sources. Likewise, while LEDs are currently provided as discrete lighting elements, and where a plurality of LEDs can be perceived as a linear light source. LEDs and other light sources exist and may become available which have the form of a continuous linear light source, and which may additionally be flexible.

Accordingly, the disclosure provides an alternate or auxiliary light source which has the form of a peripheral band surrounding a lighting fixture (or other type of fixture) base, and which can be seen from any viewpoint of the fixture. The light emitted by LED ring 832 can serve a plurality of purposes. For example, the band can emit a white or bright color to partially illuminate a room or area, for example to form a ‘night light’ or guide light, without a need to completely illuminate the area, reducing cost and avoiding emitting a possibly disturbing amount of light. The light emitted can be of the same color with a changeable intensity as well as or instead of a changeable color. The intensity and color can be changed by a switch or other user control, or can be changed by electronic circuit 802 in response to a user signal or another signal, for example an electrical signal generated by a sensor, for example a motion sensor or sensor responsive to a change in an environment of the device 100.

Another purpose for the light emitted from LED ring 832 is to signal a state or condition of any one or more of the following: device 100, the area in which device 100 is installed, the edifice, one or more designated individuals, a locale, or a wide geographic area. Examples include a status of one or more sensors within device 100, including an operational state of a microphone or camera, alarm, or motion sensor, or an operational state of device 100 generally. Various colors are indicated in FIGS. 6-7, in which shading of canopy lens 727 is light in FIG. 6, representing a white light, and more darkly shaded in FIG. 6A, indicating a non-white color, such as yellow; red, green, blue, or purple, or any other color. Other colors can be provided by the same LEDs, as well as varying levels of brightness in the same or different colors, any of which can be used to indicate a level or degree of a state.

As noted, the state of a person in the area of the device 100 can be indicated, for example as determined by sensors within device 100. For example, sensors can detect a loud event, such as a fall or cry for help, and illuminate red or other alert color. Other devices in an area can also be illuminated red, whereby support staff observes the color and render aid. Sensors can also detect an unhealthy quality in the air and indicate a warning via a designated color. Likewise, an intrusion can be indicated by a warning color, optionally an alarm sound, and optionally flashing of the warning color. A speed of the flashing can indicate relative alarm or hazard severity, as can the shade or brightness of the light. Other sensed conditions which can be indicated by LED ring 832 as described include an elevated or depressed heart rate, spoken commands, excessive occupancy, or any other condition which can be electronically sensed in the area of device 100, or in the area of other device 100 which is in electronic communication with the device indicating the state or condition. The state or condition can be communicated via one or more connections to terminals 536, or by a wireless signal which can be communicated along the Internet.

Light intensity or color emitted by LED ring 832 can additionally illuminate an appropriate walking path, as indicated by a plurality of devices 100, including a path to safety and an exit. The entire path can be illuminated, or successive devices 100 can illuminate indicating the next portion of the path. Device 100 can include a motion sensor, whereby LED ring 832 emits light only when motion is detected, and for a predetermined period of time thereafter. In this manner, successive devices 100 can illuminate an elongate path or large area only as needed based upon motion.

FIG. 7 illustrates an alternative type of device 100′ which can incorporate the components described herein for device 100, including canopy lens 727′, in this example a device for mounting a fan or other structure on a suspended pole or other suspending structure 910. Still further types of devices which can be mounted via a quick connect are disclosed in the incorporated references, any of which can include the lighting configuration disclosed herein.

All references cited herein are expressly incorporated by reference in their entirety. There are many different features of the present disclosure and it is contemplated that these features may be used together or separately. Unless mention was made above to the contrary, it should be noted that all of the accompanying drawings are not to scale. Thus, the disclosure should not be limited to any particular combination of features or to a particular application of the disclosure. Further, it should be understood that variations and modifications within scope of the disclosure might occur to those skilled in the art to which the disclosure pertains. Accordingly, all expedient modifications readily attainable by one versed in the art from the disclosure set forth herein that can be incorporated with the present disclosure are to be included as further embodiments of the present disclosure.

List of Reference Numerals:

100 electrical fixture device
300 quick connect plug/socket device
400 quick connect socket
438 socket alignment spline
442 mounting strap
444 hollow body
446 ring shaped opening
448 body interior
450 central bore
452 narrowed bore diameter portion
454 internal conductor
456 conductor connection end
458 conductor contact end
460 contactor
462 contactor spring
500 quick connect plug
502 fixture wiring terminal
524 body
526 conductive ring
534 internal conductor
536 terminal
536A terminal entry port
538 plug alignment spline
564 spindle
566 spindle bore
568 pin
570 narrowed pin diameter portion
572/572A-B radial channel
574 retaining ball
576 lower surface
578 wire channel
580 upper surface
586 bottom enclosure
588 canopy release aperture
590 terminal wire cover
592 wiring passthrough
594 housing
596 mounting aperture
598 top enclosure
602 release lever
604 lever channel
606 lever cam surface
608/608A-D lever end effector
610 pin cam follower
612 cam spring
614 lever spring
616 lever guide
618 end effector segment
620 lever button end
624/624A actuator button connector
700/700A canopy
702/702A lever actuator button
723 wifi mounting aperture
725 release actuating aperture
727 canopy lens
729 light aperture
800 sensor
802 electronic circuit
812 backup battery
826 wifi antenna
832 LED ring
834 LED
904 spindle extension
908 extension slot
910 suspending structure
932 hanger
952 hanger finial mounting nut
954 fixture wire passthrough

What is claimed is:

1. A device for connecting an electrical fixture to an electrical socket of the type including a socket body having an internal cavity which contains concentric ring-shaped openings with adjacent internal contact terminals which are electrically connected to an electrical power supply wiring, the device including
a plug rigidly fixed to the fixture and insertable into the socket, the plug having one or more male ring-shaped connectors electrically connected to the fixture and mateable with the one or more contact terminals within the socket to establish a circuit between the electrical fixture and the electrical power wiring; and
a releasable latch carried on the combination of the plug and the socket for releasably mounting the fixture on the support, the device comprising:
a housing containing an electronic circuit, the housing sized to contain a portion of the plug, the housing defining an exterior perimeter; and
a light source connected to the electronic circuit, the light source positioned to emit light circumferentially about the exterior perimeter;
the light source controllable by the electronic circuit to emit light at a selected color of a plurality of colors.

2. The device of claim 1, the housing enclosed by a canopy.

3. The device of claim 2, the canopy including a light passing lens positioned circumferentially about a perimeter of the canopy.

4. The device of claim 1, the housing including a plurality of apertures about the exterior perimeter for passing light of the light source.

5. The device of claim 3, the housing including a plurality of apertures about the exterior perimeter for passing light of the light source, the light passing lens positioned proximate the plurality of apertures.

6. The device of claim 1, further including a plurality of LEDs disposed peripherally about the plug, and
a lens covering the plurality of LEDs is configured to diffuse the light from the LEDs.

7. The device of claim 1, further including an electronic circuit connected to the plug, the plurality of LEDs connected to the electronic circuit, the electric circuit configured to change a color and/or light intensity of the LEDs in response to an electrical signal.

8. The device of claim 1, further including a sensor, the electrical signal generated by the sensor.

9. The device of claim 8, the sensor being a motion sensor.

10. The device of claim 1, wherein the releasable latch includes a pin movable between a latched and an unlatched position, the pin movable within a spindle affixed to the plug, the spindle extending through a central axis of the ring-shaped contact terminals of the socket when the plug is inserted within the socket, the latch movable along a path transverse to central axis, the latch movable to move the pin along the central axis.

11. The device of claim 10, the device further including a canopy sized larger than the housing and affixable to the housing, the canopy including a button pressable when the canopy is affixed to the housing, the device further including an end effector extending between the button and the lever, whereby the latch is moved when the button is moved.

12. A device for connecting an electrical fixture with an electrical signal, the device including
a socket including a socket body having a plurality of ring shaped internal cavities therein; an electrically conductive contact terminal disposed within each of a plurality of the cavities for establishing an electrical connection between an electrical signal and the socket;
a bore formed within the socket and including a narrowed portion;
a plug attachable to the fixture the plug having a body including a plurality of electrical terminals accessible from an exterior of the body;
the plug having a plurality of ring shaped electrical contacts each mateably passable through a ring shaped internal cavity of the socket and engageable with a contact terminal within the socket to establish a circuit between the electrical fixture and the electrical signal;
the fixture electrically connectible to the plurality of ring shaped electrical contacts of the plug by connecting one or more wires of the fixture each to one of the plurality of electrical terminals of the plug;
a spindle connected to the plug and insertable into the bore of the socket;
a pin slideable within the spindle;
one or more channels extending through the spindle;
one or more retaining balls each disposed within one of the one or more channels;
the pin cooperative with the retaining balls and channels to
slide within the spindle to a latch position to push the one or more retaining balls radially outwards within their respective channels to engage the narrowed portion of the socket bore to retain the spindle within the socket bore, and
slide within the spindle to an unlatched position to not push the one or more retaining balls radially outwards within their respective channels to thereby enable release of the spindle from within the socket bore;
the device further comprising:
a housing enclosing portions of the plug;
a plurality of LEDs disposed peripherally about the housing; and
a lens covering the plurality of LEDs.

13. The device of claim 12, the plurality of LEDs are positioned upon a ring, the device further including a plurality of apertures each positioned adjacent an LED to thereby admit passage of light from an interior of the housing to an exterior of the housing.

14. The device of claim 12, the lens diffusing the light from the LEDs.

15. The device of claim 12, the housing formed from a top portion on a side of the plug adjacent the spindle, and a bottom portion positionable on a side of the plug opposite to the spindle, the housing enclosing an electronic circuit connected to the LEDs.

16. A method of communicating information with light, comprising:
providing
a device for connecting an electrical fixture to an electrical socket of the type including a socket body having an internal cavity which contains one or more electrically conductive and concentric ring-shaped contact terminals which are electrically connected to an electrical power supply wiring, the device including
a plug rigidly fixed to the fixture and insertable into the socket, the plug having one or more male connectors electrically connected to the fixture and mateable with the one or more contact terminals within the socket to establish a circuit between the electrical fixture and the electrical power wiring; and
a releasable latch carried on the combination of the plug and the socket for releasably mounting the fixture on the support, the device comprising:
a housing containing an electronic circuit, the housing sized to contain a portion of the plug, the housing defining an exterior perimeter; and
a light source connected to the electronic circuit, the light source positioned to emit light circumferentially about the exterior perimeter;
the light source controllable by the electronic circuit to emit light at a selected color of a plurality of colors; and
using the electronic circuit to sense a condition in the area proximate the device and controlling at least one of the color, intensity, and timing of the light source using the electronic circuit to communicate the sensed condition.

17. The method of claim 16, the device further including a motion sensor, the sensed condition including motion.

18. The method of claim 17, wherein a plurality of devices are positioned along a path, whereby motion detected illuminates a portion of the path along which motion is detected.

19. The method of claim 17, the light source controlled to indicate a relative state of the sensed condition by at least one of selecting a different color emitted for each of the relative states, selecting a different intensity emitted for each of the relative states, and selecting a different timing of emitting light for each of the relative states.

20. The method of claim 16, wherein the sensed condition is a state of healthfulness in the area of the device using at least one sensor, the light source controlled to indicate a relative state of healthfulness in the area of the device.
